(19) United States
(12) Patent Application Publication
(10) Pub. No.: US 2019/0375277 A1
(43) Pub. Date: Dec. 12, 2019

(54) OPENING/CLOSING BODY DRIVE DEVICE

(71) Applicant: DENSO CORPORATION, Kariya-shi, Aichi-ken (JP)

(72) Inventor: Hiroshi ONITSUKA, Kariya-shi (JP)

(73) Assignee: DENSO CORPORATION, Kariya-shi, Aichi-ken (JP)

(21) Appl. No.: 16/478,730

(22) PCT Filed: Mar. 20, 2018
(86) PCT No.: PCT/JP2018/011091

§ 371 Date: Jul. 17, 2019

(30) Foreign Application Priority Data
Mar. 27, 2017 (JP) 2017-061192

(51) Int. Cl. B60J 1/17; E05F 15/41

(52) U.S. Cl. CPC B60J 1/17; E05F 15/695; E05F 15/41

(57) ABSTRACT

An opening/closing body drive device includes: a motor for opening and closing an opening/closing body; and a control unit that controls driving of the motor. The control unit executes a pinch detection process in a section excluding a mask section that is set on an opening-direction side from the fully-closed position of the opening/closing body. The control unit sets the length of the mask section on the basis of the use history of the opening/closing body drive device.

### TECHNICAL FIELD

The present invention relates to an opening/closing body drive device such as a power window device or a sunroof device installed in a vehicle.

### BACKGROUND ART

Patent Document 1 discloses an example of a vehicle power window device having an anti-entrapment function that prevents foreign material from being entrapped by a closing window glass. Such a power window device performs an entrapment detection process that detects that the action of the window glass has been hampered by foreign material based on the transition in the change of the rotation speed of a motor, which serves as a driving source, and stops or reverses rotation of the motor based on the detection of the foreign material to reduce the load applied to the foreign material. Further, such a power window device has a section from a fully closed position of the window glass to a predetermined position located toward an opening direction side (lower side) set as a mask section, in which the entrapment detection process is not performed, so that the entrapment detection process is not performed when the closing window glass comes into contact with a weather strip on an upper window frame.

### PRIOR ART DOCUMENT

### Patent Document

Patent Document 1: Japanese Laid-Open Patent Publication No. 2014-34831

### SUMMARY OF THE INVENTION

Problems that the Invention is to Solve

In a power window device such as that described above, aging deterioration (wear) of the weather strip decreases the speed reduction rate of the window glass when coming into contact with the weather strip. The above mask section in the entrapment detection process, however, is set to have a length corresponding to the weather strip prior to the occurrence of aging deterioration (when new). Thus, aging deterioration of the weather strip will result in the mask section being longer than necessary. In this respect, there is still room for improvement.

It is an object of the present disclosure to provide an opening/closing body drive device that allows for the setting of the appropriate mask section that is in accordance with aging deterioration of the weather strip. Means for solving the problems

In order to achieve the above object, an opening/closing body drive device includes a motor that opens and closes an opening/closing body; and a controller that controls driving of the motor. The controller executes an entrapment detection process in a section excluding a mask section set from a fully closed position of the opening/closing body toward an opening direction side. The controller sets a length of the mask section based on usage history of the opening/closing body drive device.

### BRIEF DESCRIPTION OF THE DRAWINGS

FIG. 1 is a schematic diagram of the configuration of a power window device according to one embodiment of the present disclosure.

FIG. 2 is a schematic diagram illustrating driving control of a window glass shown in FIG. 1.

FIG. 3 is a flowchart illustrating a process of a controller shown in FIG. 1.

FIG. 4 is a flowchart illustrating a process of a controller in a modification.

FIG. 5 is a flowchart illustrating a process of a controller in a modification.

### MODES FOR CARRYING OUT THE INVENTION

One embodiment of a power window device serving as an opening/closing body drive device will now be described.

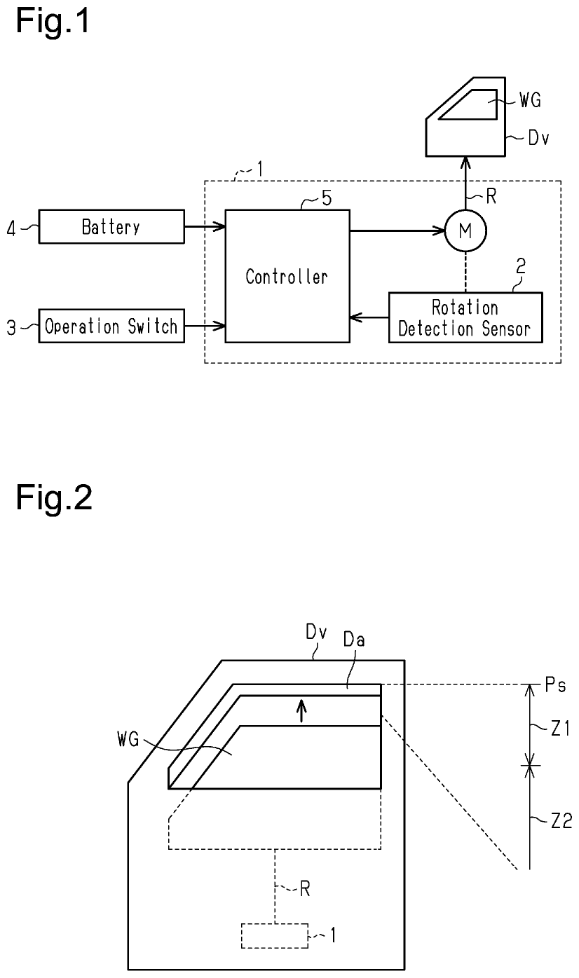

As shown in FIG. 1, a vehicle door Dv includes a vertically movable window glass WG serving as an opening/closing body. The window glass WG is drive-connected to a motor M of a power window device 1 by a wire-type or X-arm type regulator R.

The power window device 1 includes a rotation detection sensor 2, such as a Hall IC that detects rotation of the motor M, and a controller 5 that supplies power from a battery 4 to the motor M based on a signal from the rotation detection sensor 2 and a signal from an operation switch 3. The rotation detection sensor 2 outputs a pulse signal corresponding to the rotation of the motor M to the controller 5. The controller 5 determines the position and speed of the window glass WG and performs various types of control based on the input pulse signal in order to drive-control the motor M.

Specifically, when the operation switch 3 on the vehicle door Dv is operated, the controller 5 drive-controls the motor M to open or close (vertically move) the window glass WG in accordance with the operation.

The controller 5 performs an entrapment detection process that determines whether foreign material has been entrapped by the window glass WG during a closing action based on driving information (rotation speed, current value, etc.) of the motor M, and, if entrapment occurs, drive-controls the motor M to stop or reverse movement of the window glass WG.

During a closing action (upward movement), when the window glass WG reaches a mechanical lock position and rotation of the motor M is arrested, the controller 5 detects a lock current resulting from the arrest and stops supplying power to the motor M.

As shown in FIG. 2, the controller 5 recognizes the position where the rotation of the motor M was arrested (position where lock current was detected) as fully closed position Ps (zero position). Positional information on the window glass WG recognized by the controller 5 is obtained by adding the number of pulse edges from the rotation detection sensor 2 to fully closed position Ps as the window glass WG moves toward the opening direction side.

The controller 5 sets a section from fully closed position Ps to a position separated by a predetermined number of pulse edges in the opening direction side as mask section Z1 in which the entrapment detection process is not performed. That is, the controller 5 performs the entrapment detection process in a section (entrapment detection process section Z2) outside mask section Z1.

The controller 5 sets the length of mask section Z1 (number of pulse edges) based on usage history of the power window device 1. In the present embodiment, the controller 5 sets the length of mask section Z1 based on an accumulated number of times the motor M has been driven (number obtained by accumulating occurrence of driving of motor M) as the usage history of the power window device 1.

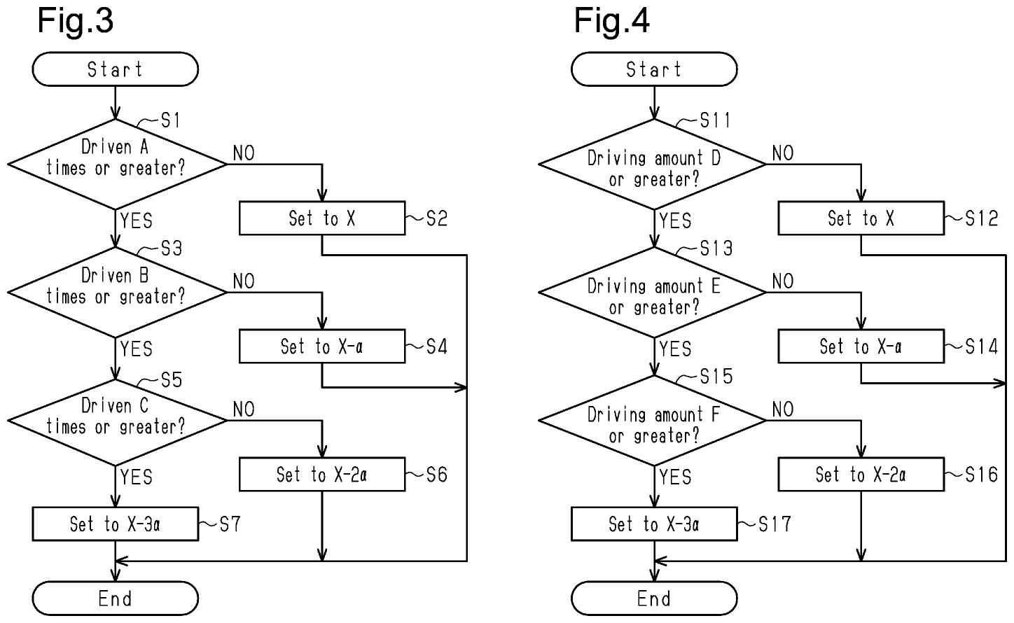

Specifically, as shown in FIG. 3, the controller 5 performs the process starting from step S1 when the window glass WG is closing.

In step S1, the controller 5 determines whether the accumulated number of times the motor M has been driven is A or greater. If the controller 5 determines that the number is less than A, the process proceeds to step S2 to set the length of mask section Z1 (number of pulse edges) to reference value X (initial setting value), which is set in advance. The reference value X is set to a length that corresponds to a state (new state) before the weather strip Da of an upper window frame (see FIG. 2) undergoes aging deterioration.

Further, in step S1, if the controller 5 determines that the accumulated number of times the motor M has been driven is A or greater, the process proceeds to step S3 to determine whether the accumulated number of times the motor M has been driven is B or greater. The comparison value “B” is set to be greater than comparison value “A” in step S1. If the controller 5 determines that the accumulated number of times the motor M has been driven is less than B, the process proceeds to step S4 to set the length of mask section Z1 by subtracting estimated reduction value α, which is set in advance, from reference value X.

Further, in step S3, if the controller 5 determines that the accumulated number of times the motor M has been driven is B or greater, the process proceeds to step S5 to determine whether the accumulated number of times the motor M has been driven is C or greater. The comparison value “C” is set to be greater than comparison value “B” in step S3. If the controller 5 determines that the accumulated number of times the motor M has been driven is less than C, the process proceeds to step S6 to set the length of mask section Z1 by subtracting a value that is twice as great as the estimated reduction value α, which is set in advance, from reference value X.

Further, in step S5, if the controller 5 determines that the accumulated number of times the motor M has been driven is C or greater, the process proceeds to step S7 to set the length of mask section Z1 by subtracting a value that is three times as great as the estimated reduction value α, which is set in advance, from reference value X.

Preferably, the values (reference value X and estimated reduction value α) used to set the length of mask section Z1 are derived in advance from experimental results or the like as optimal values for the accumulated numbers of times (A, B, C) the motor M has been driven. Further, when the comparison values (A, B, C) are set, comparison value B may be a value that is twice as great as comparison value A, comparison value C may be a value that is three times as great as comparison value A. Alternatively, the comparison values may be set in other patterns. In addition, when comparison values B and C are multiples of comparison value A, the length of mask section Z1 can be reduced with a linear function using a simple program.

The operation of the present embodiment will now be described.

During a closing action, if the accumulated number of times the motor M has been driven is less than A, the length of mask section Z1 is set to reference value X. If the accumulated number of times the motor M has been driven is less than A, the deterioration degree of the weather strip Da is low and the elasticity of the weather strip DA is still high. Thus, foreign material entrapment determination (erroneous foreign material entrapment determination) is likely to occur when the window glass WG contacts the weather strip Da. Accordingly, reference value X is set so that mask section Z1 is long enough to limit contact of the window glass WG with the weather strip Da as much as possible in entrapment detection process section Z2.

As the accumulated number of times the motor M has been driven increases in the order of A, B, and C, the length of mask section Z1 is decreased in stages. More specifically, wear occurs in the weather strip Da when the accumulated number of times the motor M has been driven is large, that is, as aging deterioration of the weather strip Da progresses. Thus, erroneous foreign material entrapment determination is less likely to occur when the window glass WG slightly contacts the weather strip Da. Further, by setting mask section Z1 as described above, entrapment detection process section Z2 is widened while reducing erroneous foreign material entrapment determination caused by the weather strip Da. This further improves safety.

The advantages of the present embodiment will now be described.

(1) The controller 5 sets the length of mask section Z1, in which an entrapment detection process is not performed, based on the usage history (accumulated number of times motor M has been driven) of the power window device 1. This sets the appropriate mask section Z1 that is in accordance with aging deterioration of the weather strip Da.

(2) The controller 5 sets the length of mask section Z1 based on the accumulated number of times the motor M has been driven, which corresponds to the usage history of the power window device 1. Thus, fewer numbers are managed compared with a case where the length is set based on, for example, an accumulated driving amount of the motor M (accumulated number of pulse edges of driven motor M). This allows the length of mask section Z1 to be set with a simple configuration.

(3) Preferably, the controller 5 decreases the length of mask section Z1 by performing a subtraction from preset reference value X with a linear function whenever the usage history of the power window device 1 becomes greater than or equal to a multiple of a fixed amount, which is set in advance. With this configuration, the appropriate length can be set for mask section Z1 with a simple program.

The above embodiment may be modified as described below.

In the above embodiment, the controller 5 sets the length of mask section Z1 based on the accumulated number of times the motor M has been driven, which corresponds to the usage history of the power window device 1. Instead, setting may be based on other usage history.

For example, as shown in FIG. 4, the controller 5 may set the length of mask section Z1 based on an accumulated driving amount of the motor M (accumulated number of pulse edges of driven motor M), which corresponds to usage history of the power window device 1.

In the process shown in FIG. 4, in step S11, the controller 5 determines whether the accumulated driving amount of the motor M (accumulated number of pulse edges) is D or greater. If the controller 5 determines that the amount is less than D, the process proceeds to step S12 to set the length of mask section Z1 (number of pulse edges) to reference value X, which is set in advance.

Further, in step S11, if the controller 5 determines that the accumulated driving amount of the motor M is D or greater, the process proceeds to step S13 to determine whether the accumulated driving amount of the motor M is E or greater. The comparison value “E” is set to be greater than comparison value “D” in step S11. If the controller 5 determines that the accumulated driving amount of the motor M is less than E, the process proceeds to step S14 to set the length of mask section Z1 by subtracting estimated reduction value α, which is set in advance, from reference value X.

Further, in step S13, if the controller 5 determines that the accumulated driving amount of the motor M is E or greater, the process proceeds to step S15 to determine whether the accumulated driving amount of the motor M is F or greater. The comparison value “F” is set to be greater than comparison value “E” in step S13. If the controller 5 determines that the accumulated driving amount of the motor M is less than F, the process proceeds to step S16 to set the length of mask section Z1 by subtracting a value that is twice as great as the estimated reduction value α, which is set in advance, from reference value X.

Further, in step S15, if the controller 5 determines that the accumulated driving amount of the motor M is F or greater, the process proceeds to step S17 to set the length of mask section Z1 by subtracting a value that is three times as great as the estimated reduction value α, which is set in advance, from reference value X.

A process such as that described above allows the aging deterioration degree of the weather strip Da to be estimated in a preferred manner based on the accumulated driving amount of the motor M.

Preferably, the values (reference value X and additional value α) used to set the length of mask section Z1 are derived in advance from experimental results or the like as optimal values for the accumulated driving amounts (D, E, F) of the motor M. Further, when the comparison values (D, E, F) are set, comparison value E may be a value that is twice as great as comparison value D, comparison value F may be a value that is three times as great as comparison value D. Alternatively, the comparison values may be set in other patterns.

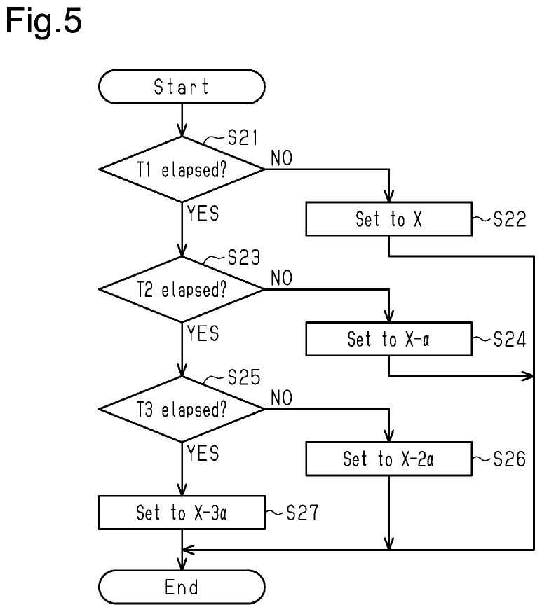

In the above embodiment and the modification shown in FIG. 4, the length of mask section Z1 is set based on the driving history of the motor M (accumulated number of times the motor M is driven or accumulated driving amount of the motor M). Instead, the controller 5 may set the length of mask section Z1 based on the used time (i.e., elapsed time from factory shipment) of the power window device 1 as shown in FIG. 5.

In the process shown in FIG. 5, in step S21, the controller 5 determines whether the used time of the power window device 1 (elapsed time from factory shipment) has reached time T1. If the controller 5 determines that the used time is less than time T1, the process proceeds to step S22 to set the length of mask section Z1 (number of pulse edges) to reference value X, which is set in advance.

Further, in step S21, if the controller 5 determines that the used time of the power window device 1 is time T1 or longer, the process proceeds to step S23 to determine whether the used time of the power window device 1 has reached time T2. The time T2 is set to be greater than time T1 compared in step S21. If the controller 5 determines that used time of the power window device 1 is less than time T2, the process proceeds to step S24 to set the length of mask section Z1 by subtracting estimated reduction value α, which is set in advance, from reference value X.

Further, in step S23, if the controller 5 determines that the used time of the power window device 1 is time T2 or longer, the process proceeds to step S25 to determine whether used time of the power window device 1 has reached time T3. The time T3 is set to be greater than time T2 compared in step S23. If the controller 5 determines that the used time of the power window device 1 is less than time T3, the process proceeds to step S26 to set the length of mask section Z1 by subtracting a value that is twice as great as the estimated reduction value α, which is set in advance, from reference value X.

Further, in step S25, if the controller 5 determines that the used time of the power window device 1 is T3 or longer, the process proceeds to step S27 to set the length of mask section Z1 by subtracting a value that is three times as great as the estimated reduction value α, which is set in advance, from reference value X.

A process such as that described above allows the aging deterioration degree of the weather strip Da to be estimated in a further improved manner based on the used time of the power window device 1.

Preferably, the values (reference value X and additional value α) used to set the length of mask section Z1 are derived in advance from experimental results or the like as optimal values for times T1, T2, T3. Further, when times T1, T2, T3 are set, time T2 may be a value that is twice as great as time T1, time T3 may be a value that is three times as great as time T1. Alternatively, times T1, T2, T3 may be set in other patterns.

In the above embodiment, the controller 5 determines increases in the accumulated number of times the motor M has been driven in stages (three stages in the embodiment) and increases the decreased amount of the length of the mask section in each stage. Instead, the controller 5 may determine increases in the accumulated number of times the motor M has been driven in less than or equal to two stages or greater than or equal to four stages. Further, for example, a map of the length of mask section Z1 (such as number of pulse edges) may be generated for the usage history of the power window device 1 (accumulated number of times the motor M is driven, accumulated driving amount of the motor M, or used time of the power window device 1) from experimental results of the like. The controller 5 may set the length of the mask section based on the generated map.

In the above embodiment, arresting of rotation of the motor M is detected based on a lock current. Instead, arrested rotation of the motor M may be detected based on the rotation speed of the motor M.

In the above embodiment, the controller 5 is arranged integrally with the motor M and fixed to the vehicle door Dv. Instead, the controller 5 may be separate from the motor M and located separately from the motor M to drive-control the motor M.

In the above embodiment, the present invention is embodied in the power window device 1 of a vehicle. Instead, the present invention may be applied to an opening/closing body drive device that controls driving of an opening/closing body other than a window glass WG (such as sunroof).

The embodiment and the modification described above may be combined where necessary.

1. An opening/closing body drive device comprising:
a motor that opens and closes an opening/closing body; and
a controller that controls driving of the motor, wherein
the controller executes an entrapment detection process in a section excluding a mask section set from a fully closed position of the opening/closing body toward an opening direction side, and
the controller sets a length of the mask section based on usage history of the opening/closing body drive device.

2. The opening/closing body drive device according to claim 1, wherein the controller sets the length of the mask section based on an accumulated number of times the motor is driven that corresponds to the usage history of the opening/closing body drive device.

3. The opening/closing body drive device according to claim 1, wherein the controller sets the length of the mask section based on an accumulated driving amount of the motor that corresponds to the usage history of the opening/closing body drive device.

4. The opening/closing body drive device according to claim 1, wherein the controller sets the length of the mask section based on used time that corresponds to the usage history of the opening/closing body drive device.

5. The opening/closing body drive device according to claim 1, wherein the controller decreases the length of the mask section by performing a subtraction from a preset reference value with a linear function whenever the usage history of opening/closing body drive device becomes greater than or equal to a multiple of a fixed amount that is set in advance.
